(19) United States
(12) Patent Application Publication
(10) Pub. No.: US 2012/0191303 A1
(43) Pub. Date: Jul. 26, 2012

(54) Method for Controlling a Restraint Device for Occupants of a Vehicle

(75) Inventors: Wilfried Bullinger, Korntal-Muenching (DE); Juergen Dickmann, Ulm (DE); Walter Eberle, Hochdorf (DE); Martin Fritzsche, Biberach (DE); Armin Huerland, Althengstett (DE); Mirko Maehlisch, Gaimersheim (DE); Uwe Merz, Stuttgart (DE)

(73) Assignee: Daimier AG, Stuttgart (DE)

(21) Appl. No.: 13/377,434

(22) PCT Filed: May 27, 2010
(86) PCT No.: PCT/EP2010/003233

§ 371 Date: Mar. 28, 2012

(30) Foreign Application Priority Data
Jun. 10, 2009 (DE) 102009025021.2

(51) Int. Cl. B60R 21/0134

(52) U.S. Cl. 701/46; 701/45

(57) ABSTRACT

A method for controlling a restraint device for occupants of a vehicle is provided. An environment of the vehicle is captured and a restraint device is triggered depending on object data and vehicle data determined in the environment. An impact probability is determined in stages based on determined object data and/or vehicle data. Depending on the determined strength of impact probability of a respective stage, a restraint device is pre-triggered or triggered, or triggering of restraint device is suppressed and determined triggering information is processed further in a next stage.

### BACKGROUND AND SUMMARY OF THE INVENTION

Exemplary embodiments of the present invention relate to a method for controlling a restraint device for occupants of a vehicle, wherein an environment of the vehicle is captured and the restraint device is triggered depending on object and vehicle data.

German Patent Document DE 2 256 246 A1 discloses a safety device for vehicles by means of which a driver can be protected through operation of an air sac—hereinafter referred to as “airbag”—in the event that the vehicle suffers a collision. In this, a single sensor is provided in order to identify obstacles, by means of which the collision can be forecast. Furthermore, an impact can be detected by means of a further sensor, whereby the airbag can be operated in stages through operation of the sensors in stages in order to identify collisions.

In addition, International Patent Application Publication WO 2009/019093 A1 describes a method and a control device for triggering of protective means for persons. The control device comprises a first interface, which provides a first signal of a planar measuring capacitative environmental sensor system, a second interface, which provides a second signal of a contact sensor system, and at least one evaluation circuit, which includes a first evaluation module that generates a first trigger signal depending on the first signal. The evaluation circuit also includes a second evaluation module, which generates a second trigger signal depending on the second signal, and a linking module, which generates a third trigger signal depending on the first and the second trigger signal. The control device also includes a trigger circuit, which triggers the protective means for persons depending on the third trigger signal.

German Patent Document DE 197 00 713 B4 discloses a vehicle occupant restraint device and a method for controlling the inflation of an airbag of the occupant restraint device, wherein a combustible gas and an oxidising gas are caused to react in a gas generator when the occupant restraint device is activated, and the resulting combustion gases are fed into the airbag. Here, as an option, at least one additional volume of an inert gas is fed into the airbag separately from the combustible gas and the oxidising gas, depending on the impact conditions.

The publication “Potential of Pre-Crash Restraints in Frontal Collisions”, Volkswagen AG, 38436 Wolfsburg, Germany, by T. Wohllebe, M. Gonter, M. Meinecke discloses a so-called pre-crash safety system for a vehicle, by means of which a point in time can be determined when a collision of a vehicle with an obstacle is no longer avoidable. It is proposed to trigger ignition of an airbag of the vehicle for protection of an occupant before the crash, at the point in time when the impact is no longer avoidable.

Exemplary embodiments of the present invention provide a method for control of a restraint device for occupants of a vehicle that is an improvement on the state of the art.

In accordance with exemplary embodiments of the present invention, the method for control of a restraint device for occupants of a motor vehicle involves determining an environment of the vehicle and triggering the restraint device depending on object data and vehicle data.

According to the invention, an impact probability is determined in stages based on the captured object data and/or vehicle data, whereby, depending on the determined strength of the collision probability, a respective stage of the restraint device is pre-triggered or triggered, or triggering of the restraint device is suppressed, and the triggering information captured in the respective stage is processed further in a next stage.

From this it results in a particularly advantageous fashion that the restraint device, which can be for example an airbag, a seat belt tensioner, an active headrest or further so-called pre-crash systems, is already triggered before the collision at a low trigger speed, and therefore “more gently” for the occupants of a vehicle, i.e., the device can be triggered with a lower risk of injury. Also, the airbag, for example, can be designed with an increased volume, as due to the early activation before the collision, movement of occupants due to the collision has not yet taken place. Through this possible enlargement, it is also, for example, particularly advantageously the case that the movement of the occupant when the collision occurs is avoided or reduced, which increases safety and protection against injuries. In particular, injury by a too rapid and too “hard” triggering of the restraint system is also avoided in the case of occupants of a vehicle who are not in an optimum position in relation to the restraint device, as the occupants can be optimally positioned in relation to further restraint devices even before the actual impact, for example by means of a slow increase in tensioning force of a seat belt. Based on the cascading process sequence, the restraint device is activated at the earliest point in time possible for triggering, whereby at the same time, based on at least one further process step, the safety of the triggering is increased.

### BRIEF DESCRIPTION OF THE DRAWING FIGURES

Embodiments of the invention are described below, referring to a drawing.

The drawing is as follows:

FIG. 1A cascading trigger method for control of the triggering of at least one restraint device for occupants of a vehicle, shown in schematic form.

### DETAILED DESCRIPTION

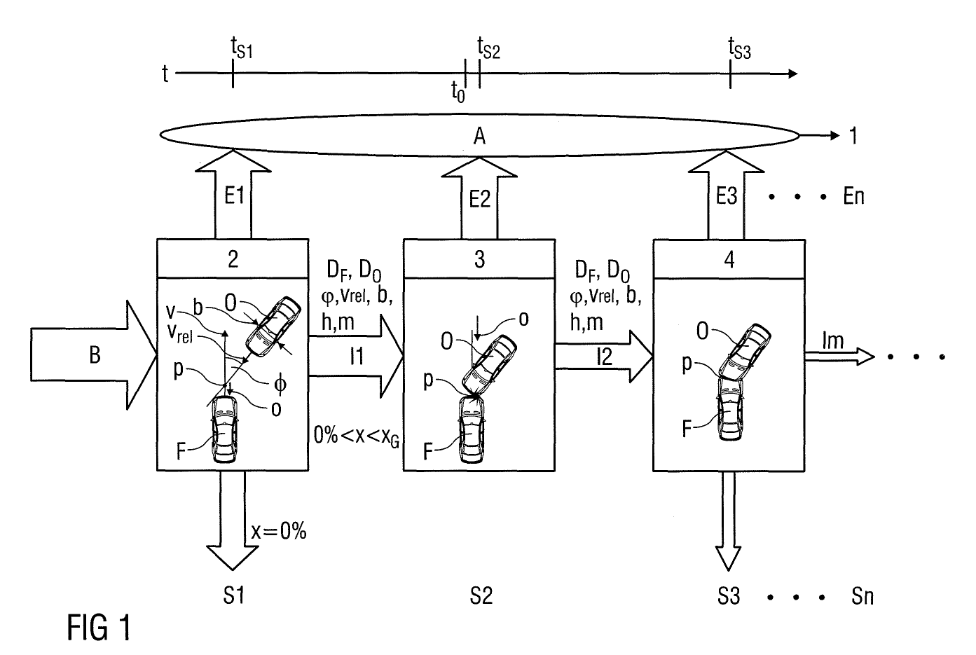

FIG. 1 shows the time-related method of a cascading triggering procedure for the control of triggering A of at least one restraint device 1 for occupants of a vehicle F. A restraint device 1 is understood to mean, for example, an airbag, a belt tensioner, an active headrest or further so-called pre-crash systems.

Vehicle F includes at least one environmental sensor system 2, a first initial impact sensor system 3 and a second initial impact sensor system 4. The environmental sensor system 2 can be, for example, a conventional camera, a stereo camera, radar sensors, lidar sensors, an infrared sensing unit and/or other suitable sensors. Environmental sensor system 2 is also preferably further intended for operation of driver assistance systems, so that preferably no additional sensor units are required in order to create environmental sensor system 2 so that it can perform the process according to the invention and its further developments. In order words, sensing of the impact is preferably possible by means of the sensors of the driver assistance systems.

First initial impact sensor system 3 consists of at least acceleration and/or piezo sensors, which are located for example in a bumper or a hood of vehicle F. As second initial impact sensor system 4 vehicle F includes at least deceleration sensors or so-called G sensors, which are integrated in the airbag control unit, for example.

In the operation designated as B of vehicle F, the environment of vehicle F is continuously captured by environmental sensor system 2 and if appropriate analysed, taking into consideration vehicle data D_{F} determined by means of further sensors. For example, the speed v and/or the direction of travel of vehicle F, the acceleration, deceleration and/or a change in the direction of travel are determined as vehicle data D_{F} (also referred to as operating data).

If an object O is detected in the vicinity of vehicle F by means of environmental sensor system 2, at least the relative speed vᵣₑₗ, the weight category m, the height h and/or width b of object O are captured and ascertained. In addition, at least a possible future impact point p, impact angle φ and impact point in time t₀ as well as the distance to object O are determined by environmental sensor system 2.

Depending on object data D_{O} captured in the environment and captured vehicle data D_{F}, restraint device 1 is then triggered or not.

For this it is provided, that in the case of an object O captured in the environment of vehicle F, the trigger process for triggering restraint device 1 corresponds to a trigger cascade, in which in the case of uncertainty of triggering information I1 to Im of a respective stage S1 to Sn upon which triggering decision E1 to En is based, triggering information I1 to Im is processed further in a further stage S2 to Sn in establishing trigger decision E2 to En of the respective stage S2 to Sn. In this, impact probability x and therefore probability of a collision of vehicle F with object O at impact point p are determined as the uncertainty of triggering information I1 to Im.

In more detail, impact probability x is determined in stages using determined object data D_{O} and/or vehicle data D_{F}. Depending on the determined seriousness of impact probability x of a respective Stage S1 to Sn, restraint device 1 is pre-triggered or triggered. If triggering of restraint device 1 is suppressed because of trigger decision E1 based on determined triggering information I1, triggering information I1 to Im is processed further in the next stage(s) S2 to Sn.

Depending on the type of staging of the trigger process, this can comprise several stages S1 to Sn, in which the or several of restraint devices 1 are triggered at the time of or after an impact.

Different trigger stages of the cascaded trigger process are described in the following paragraphs. Further intermediate stages can be implemented. The way in which trigger decision E1 to En and/or triggering information I1 to Im are established, and also the number of stages S1 to Sn, can vary in this. Here, in particular, the currently captured vehicle and/or object data D_{F} and/or D_{O} are used as triggering information I1 to Im in order to extrapolate the impact probability x and from this to extrapolate decision E1 to En.

For example, in a first stage S1, classification of captured object O (=object classification) is carried out by means of surroundings or environmental sensor system 2 and using determined object data D_{O} and vehicle data D_{F}, for example based on a weight category m, and impact probability x is determined. In the case of complete object classification and if the pre-specified limit value x_{G} of impact probability x of vehicle F with captured object O is exceeded, restraint device 1 is triggered before the impact and therefore, for example, pre-triggered at point in time t_{S1}=t₀−40 ms.

By these means it is possible in a particularly advantageous manner to trigger restraint device 1 more slowly and “more gently” for the occupants of vehicle F, so that stress and loading on the occupants through triggering A of restraint device 1 are minimised. For example, a size of an airbag can be enlarged, as because of triggering A before the impact and a position of the occupants associated with this, a larger empty space between the occupant, for example the driver, and the steering wheel of vehicle F has to be filled. Movement of the occupant is minimised through the larger form of the airbag, so that the safety of the occupant is significantly increased.

However, in order also to make possible more rapid triggering A of restraint device 1 in the other stages S2 to Sn, in which the impact, as described in the following paragraphs, in particular has already occurred, restraint device 1 is provided with triggering means that can be triggered in stages. For example, a belt tensioner is designed in such a way that different tensioning forces and tensioning speeds of the belt can be generated.

An airbag is also provided with triggering means by means of which different filling volumes of a gas can be led into the airbag at different speeds. In addition, the airbag is designed in such a way that the volume of the airbag can be controlled depending on whether the airbag was already activated before the impact or only afterwards, This means that the different positions of the occupants in the vehicle resulting from the movement of the occupants during the impact can be compensated for.

In order to control the airbag characteristics, the airbag triggering means in particular include various propelling charges, so that, for example, filling of the airbag in three or more stages is possible. The airbag also preferably exhibits different chambers in order to vary its volume in two or more stages, and different so-called active or passive venting openings, in order to control the pressure inside the airbag. At the same time, it is also possible by means of this design of the airbag or of the other restraint devices 1, such as the belt tensioner, to adapt the trigger characteristics to various body sizes of the vehicle occupants.

If object data D_{O}, such as weight category m, width b, relative speed vᵣₑₗ, impact point p, impact angle φ and/or impact point in time t₀ cannot be securely determined or cannot be captured completely, at least the object classification cannot be completely executed and it may be that impact probability x also cannot be determined. In such a case, triggering A of restraint device 1 does not occur.

Object data D_{O} determined as triggering information I1 and vehicle data D_{F} are then fed on to second stage S2.

This means that in the case of incomplete object classification and/or non-determinable impact probability x, the triggering information I1 determined in first stage S1 is transferred to second Stage S2 and there analysed and/or completed with additional impact data determined directly during the impact by means of first initial impact sensor system 3, whereby restraint device 1 is triggered depending on the result of the analysis and/or completion; otherwise triggering A of restraint device 1 is suppressed.

In the bumper of vehicle F, acceleration or piezo sensors are arranged, which, for example, trigger a pedestrian protection system, e.g., opening of a hood. If the environmental determination/capture or sensor system 2 can make a certain statement/draw a certain conclusion with regard to the weight category in first stage S1 of the triggering process, but because of the measured dynamic data, which in particular comprise object and vehicle data D_{O}, D_{F} cannot determine the impact event, i.e., in particular impact point p and impact time t₀, the data and information of first initial impact sensor system 3 are used in second stage S2, which identify an impact, are used in order to enable triggering of restraint device 1 immediately at or after the impact, already at time t_{S2} approximately 0 ms to 2 ms after impact time t₀

Here, triggering A of restraint device 1 is performed more rapidly than in first Stage S1, so that the greatest-possible safety of the occupants can be achieved. For example, the volume of the airbag is reduced, as movement of the occupant may have occurred in the direction of the airbag. This avoids a too-high exercise of force of the airbag on the passengers.

If the data from the environmental determination system or sensor system 2 and the following evaluation, such as the object classification, is indifferent with regard to the weight category m or the determined impact probability x or both, a classification of the seriousness of the impact is carried out by means of the determinable data, such as the captured initial impact data of first initial impact sensor system 3. Depending on the result of the classification of the seriousness of the impact, restraint device 1 is triggered at point in time t_{S2} approximately 3 ms to 6 ms following impact point in time t₀, or triggering is suppressed. For this, an impact limit value is specified for the seriousness of the impact. As in this example, point in time t_{S2} lies beyond impact point in time T₀, the triggering speed of restraint device 1 is increased further.

If the impact limit value is exceeded, restraint device 1 is triggered in second stage S2; otherwise triggering is suppressed and the determined triggering information I2 is passed to third stage S3 of the triggering process.

If, because of triggering information I2 in second stage S2, triggering of restraint device 1 is suppressed, restraint device 1 is triggered in third stage S3 when at least one deceleration limit value is exceeded by deceleration data determined by second initial impact sensor system 4.

In other words, if determination of impact probability x and therefore of a trigger decision E1, E2 is not possible in the previous first and second stages S1 and S2, either by means of environmental sensor system 2 or by means of initial impact sensor system 3, in third Stage S3, triggering of restraint device 1 is carried out at a point in time t_{S3} approximately 30 ms after impact time t₀, by means of second initial impact sensor system 4, for example, by means of traditional deceleration sensors in the airbag control unit, whereby triggering A is carried out at a speed that is higher than that of Stages S1 and S2, and the further triggering characteristics, such as for example the volume of the airbag, as was already adapted in Stages S1 and S2 to the respective movement of the occupants at points in time t_{S1}, t_{S2}, are adapted to the respective movement of the occupants at point in time t_{S3} so that the greatest possible protection is ensured for occupants of Vehicle F.

If no impact is identified by means of second initial impact sensor system 4, triggering of restraint device 1 is suppressed.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1-9. (canceled)

10. A method for controlling a restraint device for occupants of a vehicle, the method comprising:
capturing an environment of the vehicle;
determining object data;
determining vehicle data; and
determining in phases, based on the determined object data or the determined vehicle data, an impact probability,
wherein depending on the determined impact probability of a respective stage
the restraint device is pre-triggered,
the restraint device is triggered, or
triggering of the restraint device is suppressed and determined triggering information is further processed in a next stage.

11. The method according to claim 10, wherein in a first stage
the restraint device is triggered before the impact when the captured object data provides complete object classification and a limit value of the impact probability of vehicle with captured object is exceeded; and
triggering of the restraint device is suppressed when the captured object data does not provide complete object classification or a limit value of the impact probability of vehicle with captured object is not exceeded.

12. The method according to claim 11, wherein when the object classification is incomplete or the impact probability cannot be determined in the first stage, triggering information determined in the first stage is evaluated or completed in at least a second stage with additional impact data determined directly during impact by a first initial impact sensor system, and the restraint device is triggered depending on a result of the evaluation or completion.

13. The method according to claim 12, wherein the restraint device is triggered in the second stage when the object classification is complete in the second stage and an impact determined using the additional impact data from the second stage.

14. The method according to claim 13, wherein in the second stage, when object classification is incomplete or impact probability cannot be determined based on the additional impact data, an impact seriousness is determined and the restraint device is triggered an impact limit value is exceeded.

15. The method according to claim 10, wherein in a third stage, when at least one deceleration limit value of deceleration data is exceeded, the restraint device is triggered, wherein the deceleration data is determined by a second initial impact sensor system, which includes deceleration sensors.

16. The method according to claim 10, wherein the object data is a weight category, width, height, relative speed, angle of impact, point of impact or distance to a captured object.

17. The method according to claim 10, wherein the vehicle data is a speed, direction of travel, change of direction, acceleration or deceleration.

18. The method according to claim 10, wherein the impact probability is determined from vehicle data and object data.
